(19) United States
(12) Patent Application Publication
(10) Pub. No.: US 2007/0069695 A1
(43) Pub. Date: Mar. 29, 2007

(54) Power controller for vehicle

(76) Inventors: Cheol-Seob Lee, Taegu-Si (KR); Yang-Youn Choi, Kyungki-Do (KR)

Correspondence Address: BARLEY SNYDER, LLC, 1000 WESTLAKES DRIVE, SUITE 275, BERWYN, PA, 19312, US

(21) Appl. No.: 10/564,600

(22) PCT Filed: Jul. 16, 2004
(86) PCT No.: PCT/KR04/01779

§ 371 Date: Nov. 22, 2006

(30) Foreign Application Priority Data
Jul. 16, 2003 (KR) 10-2003-0048873

(51) Int. Cl. H02J 7/04

(52) U.S. Cl. 320/150

(57) ABSTRACT

An electric power controller for vehicle comprises an overheat detector, a voltage detector, a voltage converter, a switching unit, and a controller. The overheat detector detects whether a power line supplying power from a vehicle battery to vehicle load is overheated. The voltage detector detects a voltage of the vehicle battery. The voltage converter converts power from the vehicle battery into a proper voltage and outputs a switching control signal reflecting the proper voltage. The switching unit performs ON/OFF switching operations based on the switching control signal to control power from the vehicle battery to the vehicle load. The controller receives an overheat signal from the overheat detector and the voltage from the voltage detector, determines whether there is an abnormal current, and outputs a switching control signal, corresponding to a change of the voltage, to the switching unit.

### TECHNICAL FIELD

The present invention relates to an apparatus for controlling power supplied to load, and more particularly to an electric power controller for a vehicle capable of controlling power supplied to vehicle load.

### BACKGROUND ART

An apparatus for controlling power (for example, an intelligent power switch (IPS)) determines whether a power supply providing power to load is normally operated, and breaks power to protect the loads against any abnormal state when an abnormal state occurs. However, a prior art electric power controller had been operated to detect only overheating generated in a power line and cut power so as not to supply power to load. Therefore, in the case that a transient current is generated in power supplied to load, the prior art electric power controller cannot detect any abnormal state before overheat is generated in a power line. Also, if a current quantity is transiently exceeded or if there is an intermittent short that a state that a current quantity is transiently exceeded occurs repeatedly, overheating does not occur in a power line, and thus the prior art electric power controller cannot interrupt power supplied to load.

Accordingly, in the prior art, an expensive power line capable of enduring overheating is used. For example, an expensive power line capable of enduring a relatively high voltage at least 20% higher than a reference voltage has been utilized. Accordingly, the prior art electric power controller has disadvantages in that unnecessary costs are added when implementing a system or product. Especially, the prior art electric power controller cannot protect a load circuit against a transient current.

Meanwhile, even though there are some examples, such as systems and products, which adopt such a prior art electronic power controller, it has never been adopted to a vehicle. However, as vehicle features increases, special functions or high quality parts/circuits, which are installed in a vehicle according to an owner's selection, have now become a standard feature such that they are installed in vehicles. Therefore, a plurality of deluxe parts/circuit wirings are installed in vehicles currently coming onto the market. In a prior art vehicle, its parts/circuits are protected against abnormal state using a connection configuration of a fuse or relay circuit, which requires a plurality of wirings which consume a relatively large area therein, and increases manufacturing costs (Refer to FIG. 4). Also, the prior art electric power controller cannot protect vehicle load against a transient current, but instead must utilize relatively expensive power lines.

As such, the present applicant of this invention recognized a need to improve and adapt an electric power controller suitable to a vehicle, and implemented a method for applying the same to a vehicle.

As mentioned above, a currently developed vehicle includes a plurality of parts/circuit wirings, for example, vehicle loads inputting power, such as windshield wipers, an air conditioner, headlights, fog lights, Fans, a CDP, a vehicle navigator, a vehicle PC, etc. Also, a vehicle has circuits for controlling vehicle loads, for example, circuits for controlling the windshield wipers, the headlights, the horn, turn and hazard lights, etc. These control circuits have a power supply break unit (for example, a fuse, a relay etc.), a supplying power magnitude adjusting unit (an automatic speed controller for the windshield wipers, an automatic light intensity controller of the headlights etc.), and a signal connecting unit between a central controlling system and ECUs (Electronic Control Units), etc.

Therefore, in order to specifically implement an electric power controller which is improved and adapted to a vehicle, design specifications for the vehicle must be sufficiently considered. At the same time, space selection for installing circuits/wiring for respective loads therein and cost reduction etc. must be sufficiently considered.

Also, since a vehicle is closely related to the driver's safety, concrete causes of breakdown, such as non-operation of vehicle load by breaking power or damage of a specific vehicle load by a transient current must be easily recognized by a user (or vehicle repairman).

Meanwhile, a variety of electrical/electronic systems (circuit units for controlling various kinds of vehicle loads) are integrated and aligned in a junction box in a vehicle currently coming onto the market. Therefore, an electric power controller of the present invention is preferably installed in such a junction box such that it is easy to conduct vehicle repair or management.

### DISCLOSURE OF THE INVENTION

Therefore, the present invention has been made in view of the above problems, and it is an object of the present invention to provide an electric power controller for a vehicle capable of effectively detecting whether a power state is normal to protect vehicle load based on a result thereof.

It is another object of the present invention to provide an electric power controller adapted to a vehicle, which is designed based on consideration of space selection for installing circuits/wiring of respective vehicle loads and cost reduction, etc., considering a design specifications of the vehicle.

It is a further object of the present invention to provide an electric power controller for a vehicle implemented to be integrated with a function of controlling a magnitude of power supplied to vehicle load.

It is a still another object of the present invention to provide an electric power controller for a vehicle capable of enabling a user (for example, a vehicle repairman) to recognize concrete causes of breakdown of the vehicle, such as non-operation of vehicle load as power is broken or damage of a specific vehicle load by a transient current.

It is another yet object of the present invention to provide an electric power controller for a vehicle capable of easily accessing vehicle repair and management.

In accordance with an aspect of the present invention, the above and other objects can be accomplished by the provision of an electric power controller for vehicle comprises an overheat detector for detecting whether a power line supplying power from a vehicle battery to vehicle load is overheated, a voltage detector for detecting a voltage of the vehicle battery, a voltage converter for converting power from the vehicle battery into a proper voltage and outputting a switching control signal reflecting the proper voltage, a switching unit for performing ON/OFF switching operations based on the switching control signal to control power from the vehicle battery to the vehicle load, and a controller for inputting an overheat signal from the overheat detector and the voltage from the voltage detector, determining whether there is an abnormal current, and outputting a switching control signal, corresponding to a result to analyze a change of the voltage, to the switching unit.

Therefore, since the present invention analyzes a change of voltage of vehicle power and also determines overheat generated when a power line is overheated as well, the present invention can detect an abnormal current before a power line is overheated, thereby protecting vehicle load against transient current. Also, the present invention does not require relatively expensive power lines for enduring such overheat.

According to one aspect of the present invention, the controller outputs determination information of the abnormal current according to the change of the voltage, and the electric power controller further comprises a diagnostic information output unit for storing the determination information of the abnormal current and outputting the same to an external vehicle controller.

Therefore, the present invention can enable a user (for example, a vehicle repairman) to recognize concrete causes of vehicle breakdown, such as non-operation of vehicle load due to breaking power or damage of a specific vehicle load due to a transient current, etc.

According to an additional aspect of the present invention, the controller controls the switching unit to switch its OFF state to its ON state when receiving a reset signal from an external vehicle controller.

Therefore, when power is broken due to an abnormal current, in order to re-operate vehicle load, the prior art technique using a fuse and relay circuits requires repair of the vehicle such as replacement of the fuse. However, the above construction of the present invention can easily re-operate vehicle load. For example, the present invention can enable a user to re-operate vehicle load by pressing buttons such as a reset button while he/she is driving the vehicle, though. Even though operation of vehicle load is not preferable while a transient current occurs, it is necessary to drive a vehicle in urgent situations. Of course, according to the features of the present invention as will be described later, the magnitude of effective power of power outputted from the switching unit 115 can be adjusted, even in a state that transient current occurs.

In accordance with another aspect of the present invention, an electric power controller for a vehicle comprises an overheat detector for detecting whether a power line supplying power from a vehicle battery to vehicle load is overheated, a voltage detector for detecting a voltage of the vehicle battery, a voltage converter for converting power from the vehicle battery into a proper voltage and outputting a switching control signal reflecting the proper voltage, a switching unit for performing ON/OFF switching operations based on the switching control signal to control power from the vehicle battery to the vehicle load, and a controller for inputting an overheat signal from the overheat detector and the voltage from the voltage detector, determining whether there is an abnormal current, outputting a switching control signal, corresponding to a result to analyze change of the voltage, to the switching unit, and adjusting occurrence intervals of switching control signals, corresponding to respective ON and OFF states, to control the magnitude of effective value of vehicle power supplied to the vehicle load via the switching unit.

Therefore, since the electric power controller of the present invention performs an adjustment of a magnitude of power supplied to vehicle load, it does not require separate parts (circuit for adjusting load power, a register for DRL (Day Run Light), etc.) for adjusting power supplied to respective vehicle loads. Accordingly, the present invention can effectively reduce costs and secure a space for arranging vehicle parts. Also, since a magnitude of voltage of power supplied to vehicle load can be controlled, for example, loads of 14V group can be adopted even in a 42V system. Here, the adjustment of a magnitude of power supplied to vehicle load is, for example, to control windshield wipers slowly when the vehicle drives slowly and to control the headlights to emit more intensely when the vehicle drives in the dark.

According to one aspect of the present invention, the controller adjusts occurrence intervals of switching control signals corresponding to respective ON and OFF states if the vehicle battery outputs a transient current, so as to reduce a magnitude of power supplied to the vehicle load.

Therefore, the present invention can reduce voltage supplied to vehicle load to a proper voltage when transient current is inputted thereto, therefore the vehicle load can be stably operated.

In accordance with another yet aspect of the present invention, an electric power controller for a vehicle comprises an overheat detector for detecting whether a power line supplying power from a vehicle battery to the vehicle load is overheated, a voltage detector for detecting a voltage of the vehicle battery, a voltage converter for converting power from the vehicle battery into a proper voltage and outputting a switching control signal reflecting the proper voltage, a switching unit for performing ON/OFF switching operations based on the switching control signal to control power from the vehicle battery to the vehicle load, and a controller for inputting an overheat signal from the overheat detector and the voltage from the voltage detector, determining whether there is an abnormal current, and outputting a switching control signal, corresponding to a result to analyze change of the voltage, to the switching unit, wherein the electric power controller is mounted to the junction box as compliant pins of the electric power controller are inserted into throughholes in the printed circuit board of the junction box.

Therefore, since the electric power controller of the present invention is installed in a junction box, repair and management for a vehicle can be easily conducted.

### DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the construction of an electric power controller for a vehicle according to the present invention;

FIG. 2 is a waveform of input voltage of a switching unit according to the present invention;

FIG. 3 is a waveform of output voltage of a switching unit according to the present invention;

FIG. 4 is a block diagram illustrating a prior art circuit for controlling windshield wipers;

FIG. 5 is a block diagram illustrating an electric power controller of a vehicle for controlling windshield wipers;

FIG. 6 is a perspective view illustrating an electric power controller for a vehicle installed in a printed circuit board of a junction box by compliant pins of the electric power controller; and

FIG. 7 is an enlarged perspective view illustrating an electric power controller for a vehicle.

### BEST MODE

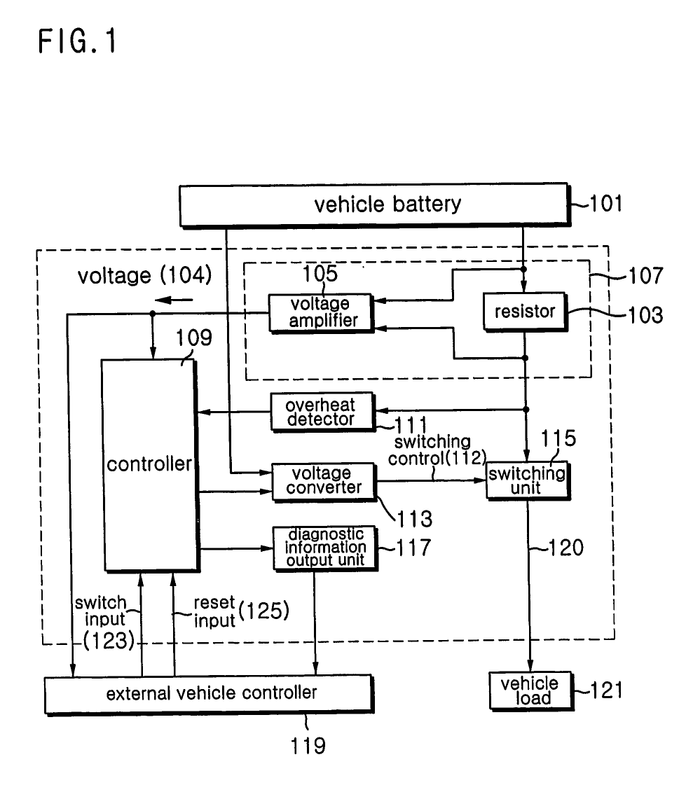

FIG. 1 is a block diagram illustrating the construction of an electric power controller for a vehicle according to the present invention.

As shown in FIG. 1, the electric power controller for a vehicle comprises an overheat detector 111 for detecting whether a power line 102 supplying power from a vehicle battery 101 to vehicle load 121 is overheated, a voltage detector 107 for detecting a voltage 104 of the vehicle battery 101, a voltage converter 113 for converting power from the vehicle battery 101 into a proper voltage and outputting a switching control signal reflecting the proper voltage 112, a switching unit 115 for performing ON/OFF switching operations based on the switching control signal 112 to control power from the vehicle battery 101 to the vehicle load 121, and a controller 109 for inputting an overheat signal from the overheat detector 111 and the voltage 104 from the voltage detector 107, determining whether there is an abnormal current, and outputting a switching control signal 112, corresponding to a result to analyze a change of the voltage, to the switching unit 115.

The vehicle battery 101 supplies its power to a variety of vehicle loads such as vehicle load 121 through a power line 102. Here, the vehicle load 121 includes an air conditioner, headlights, fog lights, fans, a CDP, a navigator, a vehicle PC and the like.

The overheat detector 111 detects whether the power line 102 is overheated, and transmits an overheat detection signal to the controller 109 if overheating is detected in the power line 102. Here, the overheat detector 111 was already well-known in the field of the electronic power controller before filing the present application, therefore a detailed description thereon will be omitted in this application.

The voltage converter 113 inputs and coverts power from the vehicle battery 111 into a proper voltage. After that it outputs a switching control signal, reflecting the proper voltage, to the switching unit 115. The switching unit 115 performs ON/OFF switching operations according to the switching control signal to control flow of power from the vehicle battery 101 to vehicle load 121. If the controller 109 inputs an overheat detection signal from the overheat detector 111, it then outputs a switching control signal 112, corresponding to an OFF state, to the switching unit 115.

As mentioned above, operations of the overheat detector 111, the voltage converter 113, the switching unit 115 and the controller 109 are similar to those of the prior art electronic power controller such that they detect only overheat generated in the power line 102 and break power supplied thereto. As such, their detailed description will be omitted in the description of the present invention.

According to an aspect of the present invention, the voltage detector 107 detects voltage of the vehicle battery 101. Those skilled in the art can easily appreciate that a technique for measuring voltage of power from a power supply can be easily implemented. For example, the voltage detector 107 may be implemented with a resistor 103 connected in series to a power line and a voltage amplifier 105 for amplifying a voltage difference obtained between both terminals of the resistor 103, in which the voltage amplifier 105 is connected to both of the terminals of the resistor 103.

Here, since the resistor 103 has a relatively very small resistance such that it drops a relatively small voltage, the voltage amplifier 105 linearly amplifies the relatively small dropped voltage.

According to an aspect of the present invention, the controller 109 inputs the voltage 104 from the voltage amplifier 105 and analyzes changes of the voltage 104 to determine whether there is an abnormal current. Therefore, even though the state occurs in the prior art, but the present invention can detect the abnormal current before the power line is overheated. Also, since the voltage 104 is analyzed, the present invention can detect a case where a current quantity is transiently exceeded or an intermittent short that a state that a current quantity is transiently exceeded occurs successively. If the abnormal current is detected, the controller 109 generates a switching control signal 112 corresponding to an OFF state to break power supplied to vehicle load 121.

According to an additional aspect of the present invention, the electronic power controller of the present invention further includes a diagnostic information output unit 117 inputting determination information of the abnormal current from the controller 109 according to the change of the voltage and outputting the determination information to an external controller (for example, an external vehicle controller 119).

The diagnostic information output unit 117 enables a user (for example, a vehicle repairman) to recognize concrete causes of vehicle breakdown such as non-operation of vehicle loads due to breaking power or damage of a specific vehicle load due to a transient current, etc. Also, the diagnostic information output unit 117 can store information of dead shorts, intermittent shorts, line-breaks etc, and can output the same.

The diagnostic information output unit 117 can output the determination information of an abnormal current to an ECU of a vehicle. Also, according to circumstances, the diagnostic information output unit 117 may be connected to an external controlling device (or measurement equipment in a vehicle repair shop) via a connector (not shown) to communicate therebetween.

According to one aspect of the present invention, the controller 109 enables the switching unit 115 to switch an OFF state to an ON state if a reset signal is inputted from the external vehicle controller 119.

As such, when power is broken due to an abnormal current, in order to re-operate vehicle load, the prior art technique using a fuse and relay circuits requires repair of the vehicle such as replacement of the fuse, etc. However, the above construction of the present invention can easily re-operate vehicle load. For example, the present invention can enable a user to re-operate the vehicle loads by pressing buttons such as a reset while he/she is driving the vehicle. Even though operating vehicle loads is not preferable while a transient current occurs, it is necessary to drive a vehicle in urgent situations. Of course, according to the features of the present invention as will be described later, the magnitude of effective power of power outputted from the switching unit 115 can be adjusted, even in a state that transient current occurs.

Meanwhile, according to an additional aspect of the present invention, the voltage detector 107 outputs the voltage 104 to the external vehicle controller 119.

The above aspect of the present invention enables the external vehicle controller 119 to monitor the voltage 104 of power of the vehicle battery. Here, when the voltage 104 is inputted to be monitored in the external vehicle controller 119, those skilled in the art can easily appreciate that the methods for monitoring the voltage 104 can be implemented in a variety of ways.

According to an aspect of the present invention, the controller 109 adjusts occurrence intervals of a switching control signal 112 corresponding to an ON state and a switching control signal 112 corresponding to an OFF state to control the magnitude of effective value of the vehicle power supplied to vehicle load via the switching unit 115.

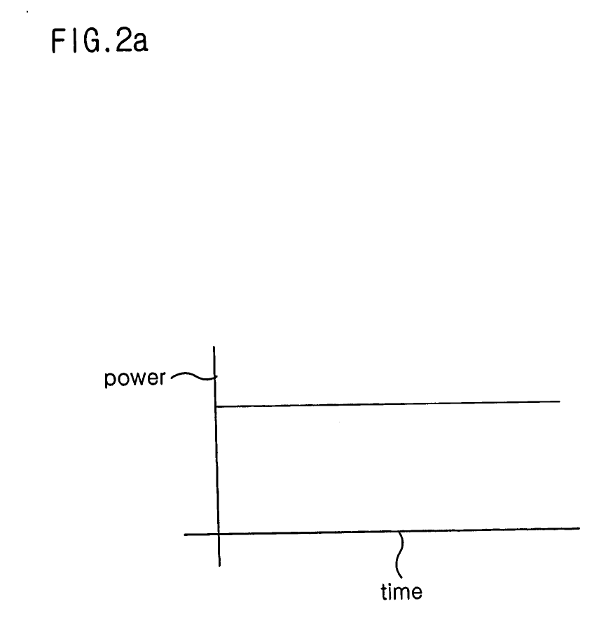

The feature of the above aspect is described with reference to FIG. 2.

In case that the switching control signal 112 is in an ON state, an output voltage is outputted from the switching unit 115, and when the switching control signal 112 is in an OFF state, an output voltage is not outputted from the switching unit 115.

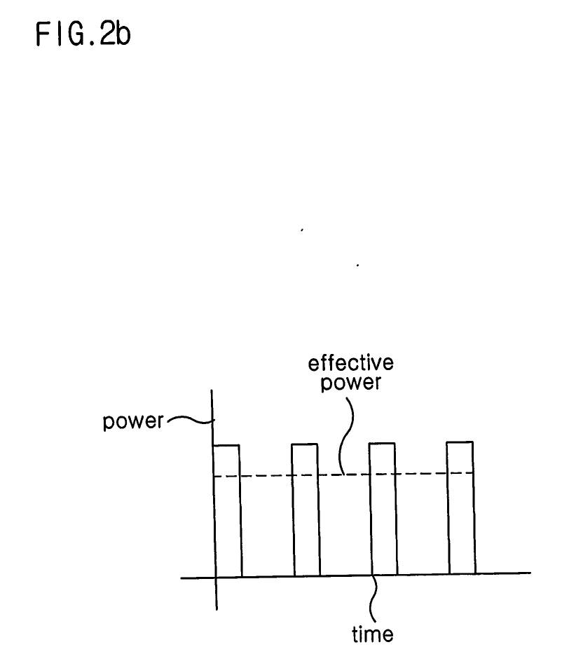

Accordingly, when occurrence intervals of switching control signals corresponding respectively to ON and OFF states are adjusted, the switching unit 115 inputs an input voltage in the form of DC as shown in FIG. 2 and outputs an output voltage in the form of pulses as shown in FIG. 3. Therefore, the controller 109 of the present invention adjusts the ON/OFF occurrence intervals to control the number of pulses, intervals, and widths etc, thereby controlling the magnitude of effective power of the power outputted from the switching unit 115.

According to one aspect of the present invention, if the controller 109 analyzes a change of the voltage 104 and determines that vehicle power includes transient current, it adjusts the ON/OFF occurrence intervals to reduce the magnitude of power supplied to vehicle load 121.

Therefore, even if transient current is supplied thereto, voltage can be reduced to a proper voltage to be supplied to a corresponding vehicle load such that the corresponding vehicle load can stably operate.

Referring to FIG. 1, a reference numeral 123 will be described in detail below. The external vehicle controller 119 transmits a switching signal 123 to the electronic power controller, so that the switching unit 115 breaks vehicle power. Even though one embodiment of FIG. 1 has described wherein a single electronic power controller controls a single vehicle load, those skilled in the art can easily appreciate that a single electronic power controller can be designed to control a plurality of vehicle loads. Also, the external vehicle controller 119 may transmit a control signal to the electronic power controller so that a magnitude of vehicle power can be adjusted (which was not illustrated in FIG. 1).

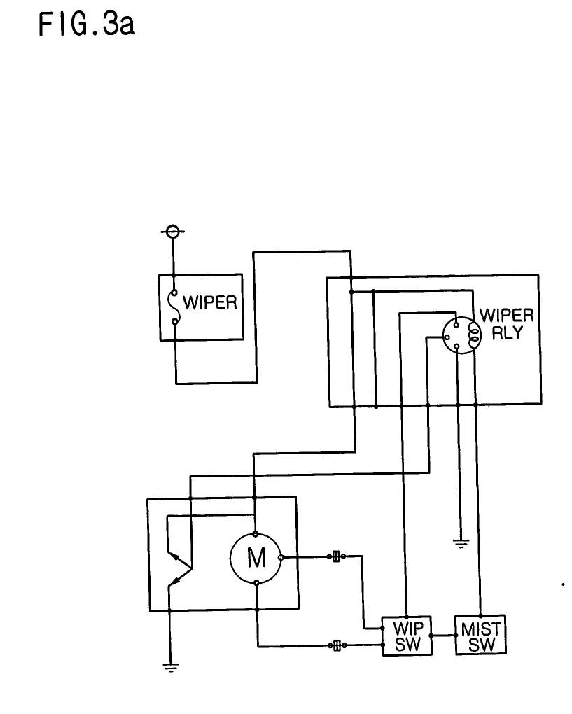

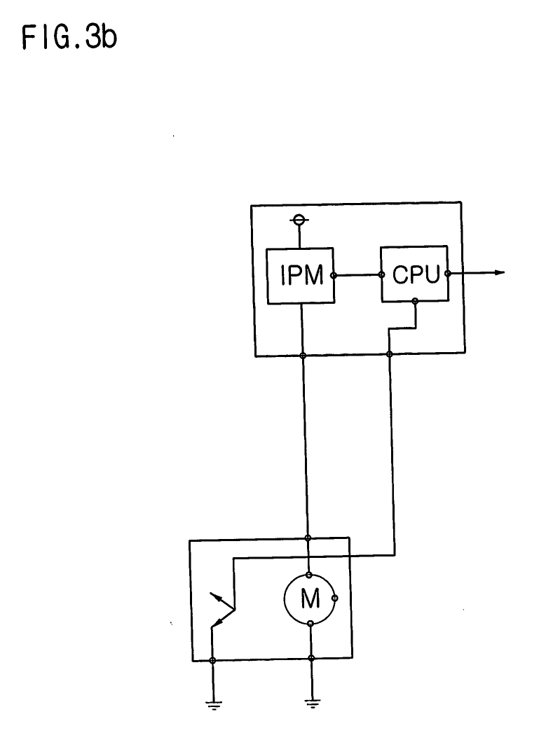

FIG. 4 is a block diagram illustrating a prior art circuit for controlling windshield wipers, and FIG. 5 is a block diagram illustrating an electric power controller of a vehicle for controlling windshield wipers.

First of all, the acronym IPM in FIG. 5 stands for an Intelligent Power Module, which was devised for the electronic power controller according to the present invention. Also, the CPU of FIG. 5 is a controlling unit for controlling windshield wipers of a vehicle may be a central processing unit.

In comparison with FIGS. 4 and 5, the prior art technique requires a fuse, a relay circuit and 12 power lines, which complicates the prior art system and increases manufacturing costs. However, the present invention does not require a fuse and relay circuit, even though an IPM is added thereto, and reduces the number of power lines to four. Also, with reference to FIG. 5, since the IPM can control the magnitude of power supplied to the windshield wipers, a motor (MTR) for the windshield wipers can be operated at a high speed (HI) and low speed (LO). Also, since an automatic windshield wiper function is integrated therewith, the circuit can be simply implemented therein. Accordingly, the present invention can reduce the manufacturing costs to less than half those of the prior art, and simply implement wirings.

According to an aspect of the present invention, the electronic power controller of the present invention is installed in a printed circuit board of a junction box and electrically connected thereto.

Since the electronic power controller is electrically connected to a printed circuit board (PCB) of a junction box, it can transmit and receive electrical signals to and from the PCB. Here, the electric power controller is preferably connected to the PCB by soldering.

Meanwhile, according to one aspect of the present invention, the electric power controller is connected to the PCB of the junction box using compliant pins thereof.

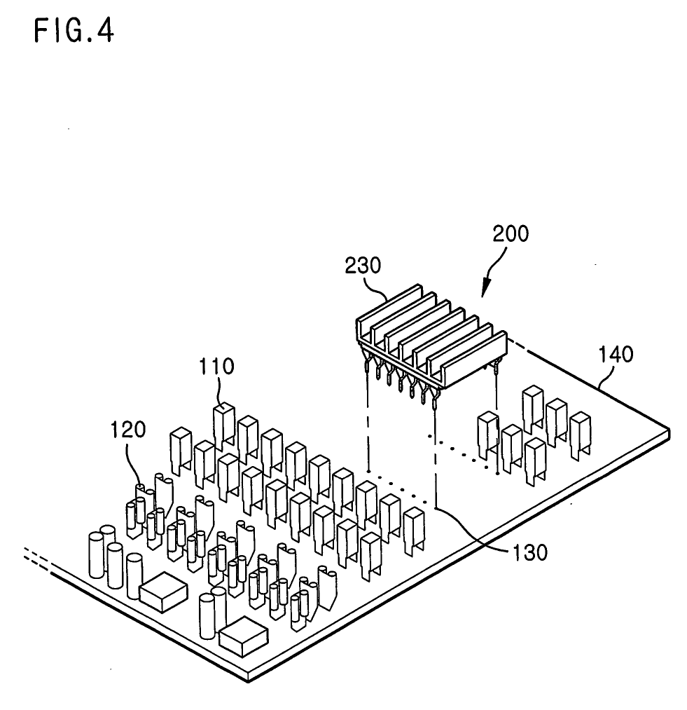

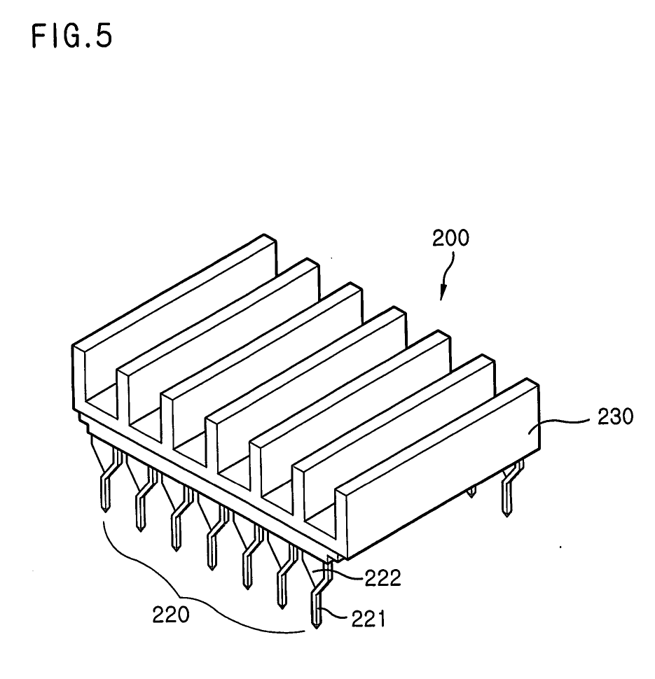

The features of the above aspect of the present invention will be described with reference to FIGS. 6 and 7.

A main printed circuit board (PCB) 140 installed in a junction box (not shown) includes female connecting terminals 110 and 120 for connecting a plurality of relays and fuses (not shown), and circuits for a basic specification of a vehicle, such as an ETACS (Electronic Time and Alarm Control System), a door lock, a power window etc. thereon. The opposite side of the main PCB 140 includes male connecting terminals (not shown) connected to a wire harness (not shown). Also, the main PCB 140 has a plurality of throughholes 130 for installing the electric power controller 200 therethrough.

The electric power controller 200 of the present invention has input/output interface terminals 220 thereunder. The input/output interface terminals 220 are implemented with compliant pins 221. Elastic parts 222 of the compliant pins 221 are inserted into the throughholes 130 of the PCB. Here, the electric power controller 200 is fixedly connected to the main PCB 140 without soldering processes as the compliant pins 221 mechanically inserting into the throughholes 130 are fixed therethrough by elasticity of the elastic parts 222, even in a state that external pressure is applied thereto. Here, the technique for fixing a specific electric part to a PCB as compliant pins such as compliant pins 221 are inserted into throughholes such as throughholes 130 without soldering processes as is well known to those skilled in the art.

Meanwhile, even though the embodiment of the present invention is described through FIGS. 6 and 7 as the electric power controller is implemented with a module, the electric power controller may be implemented within a housing. Also, the housing may be further implemented to include compliant pins therein.

In the aspect of the present invention mentioned above, the electric power controller 200 for vehicle is directly installed in a junction box.

According to an aspect of the present invention, the electric power controller is installed on an external printed circuit board externally located at a junction box, and electrically connected thereto by a line connector, in which one end of the line connector is connected to an input/output interface terminal of the external PCB and the other end is connected to an input/output interface terminal of the junction box.

The aspect of the present invention above may be adopted to a case where an electric power controller 200 cannot be directly installed in a junction box. The electric power controller 200 is installed in a separate PCB (not shown) externally located at a junction box and then electrically connected to the junction box. Here, the junction box may be implemented to include a PCB or not include a PCB. The PCB according to the preferred embodiment of the present invention is implemented with a module in the form of a box. The PCB installing the electric power controller 200 is electrically connected to the junction box by a line connector such that one end of the line connector is connected to an input/output interface terminal of the PCB and the other end is connected to an input/output of the junction box. Therefore the PCB can transmit/receive signals to/from the junction box.

Such embodiments of the present invention are described in Korean Patent Publication No. 10-2002-0009545 filed by the present applicant. With reference to FIG. 3 disclosed in the Korean Patent Publication, the electric power controller 200 is installed in a module in the form of a box externally located at the junction box. More specifically, the electric power controller 200 is installed at a PCB in a module in the form of a box. The PCB has a groove of an input/output interface terminal (see a reference numeral 311). One end (a first connecting unit) of the line connector is connected to the groove of the terminal and the other end (a second connecting unit) is connected to a groove of the input/output interface terminal, which is formed at an external junction box (not shown). Therefore, electrical signals can be bidirectionally carried through the line connector connecting the two grooves.

Additionally, the electric power controller 200 has a heat sink 230 installed on its upper side. Therefore, the heat sink 230 emits heat generated by operations of the electric power controller 200 to cool the electric power controller 200.

### INDUSTRIAL APPLICABILITY

As mentioned above, since the present invention analyzes a change of voltage of vehicle power and also determines overheat generated when a power line is overheated as well, the present invention can detect an abnormal current before a power line is overheated, thereby protecting vehicle load against transient current. Also, the present invention does not require relatively expensive power lines for enduring such overheat.

The present invention can enable a user (for example, a vehicle repairman) to recognize concrete causes of vehicle breakdown, such as non-operation of vehicle load due to breaking power or damage of a specific vehicle load due to a transient current, etc.

Also, when power is broken due to an abnormal current, in order to re-operate vehicle load, the prior art technique using a fuse and relay circuits requires repair of the vehicle such as replacement of the fuse. However, the above construction of the present invention can easily re-operate vehicle load. For example, the present invention can enable a user to re-operate vehicle load by pressing buttons such as a reset button while he/she is driving the vehicle, though. Even though operation of vehicle load is not preferable while a transient current occurs, it is necessary to drive a vehicle in urgent situations. Of course, according to the features of the present invention as will be described later, the magnitude of effective power of power outputted from the switching unit 115 can be adjusted, even in a state that transient current occurs.

Also, since the electric power controller of the present invention performs an adjustment of a magnitude of power supplied to vehicle load, it does not require separate parts (circuit for adjusting load power, a register for DRL (Day Run Light), etc.) for adjusting power supplied to respective vehicle loads. Accordingly, the present invention can effectively reduce costs and secure a space for arranging vehicle parts. Also, since a magnitude of voltage of power supplied to vehicle load can be controlled, for example, loads of 14V group can be adopted even in a 42V system. Here, the adjustment of a magnitude of power supplied to vehicle load is, for example, to control windshield wipers slowly when the vehicle drives slowly and to control the headlights to emit more intensely when the vehicle drives in the dark.

Also, the present invention can reduce voltage supplied to vehicle load to a proper voltage when transient current is inputted thereto, therefore the vehicle load can be stably operated.

Also, since the electric power controller of the present invention is installed in a junction box, repair and management for a vehicle can be easily conducted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-5. (canceled)

6. An electric power controller for a vehicle, comprising:
an overheat detector for detecting whether a power line supplying power from a vehicle battery to a vehicle load is overheated;
a voltage detector for detecting a voltage of the vehicle battery;
a voltage converter for converting power from the vehicle battery into a proper voltage and outputting a switching control signal reflecting the proper voltage;
a switching unit for performing ON/OFF switching operations based on the switching control signal to control power from the vehicle battery to the vehicle load; and
a controller for inputting an overheat signal from the overheat detector and the voltage from the voltage detector, determining whether there is an abnormal current, outputting a switching control signal, corresponding to a change of the voltage, to the switching unit, and adjusting occurrence intervals of switching control signals, corresponding to respective ON and OFF states, to control the magnitude of effective value of vehicle power supplied to the vehicle load via the switching unit.

7. The electric power controller as set forth in claim 6, wherein:
the controller outputs determination information of the abnormal current according to the change of the voltage; and
the electric power controller further comprises a diagnostic information output unit for storing the determination information of the abnormal current and outputting the same to an external vehicle controller.

8. The electric power controller as set forth in claim 6, wherein the controller controls the switching unit to switch its OFF state to its ON state when receiving a reset signal from an external vehicle controller.

9. The electric power controller as set forth in claim 6, wherein the voltage detector outputs the voltage to an external vehicle controller.

10. The electric power controller as set forth in claim 6, wherein the voltage detector comprises:
an element for measuring a voltage of the vehicle battery; and
an amplifier for amplifying a voltage difference between terminals of the element.

11. The electric power controller as set forth in claim 6, wherein the controller adjusts occurrence intervals of switching control signals corresponding to respective ON and OFF states if the vehicle battery outputs a transient current, so as to reduce a magnitude of power supplied to the vehicle load.

12. An electric power controller for a vehicle, comprising:
an overheat detector for detecting whether a power line supplying power from a vehicle battery to a vehicle load is overheated;
a voltage detector for detecting a voltage of the vehicle battery;
a voltage converter for converting power from the vehicle battery into a proper voltage and outputting a switching control signal reflecting the proper voltage;
a switching unit for performing ON/OFF switching operations based on the switching control signal to control power from the vehicle battery to the vehicle load; and
a controller for inputting an overheat signal from the overheat detector and the voltage from the voltage detector, determining whether there is an abnormal current, and outputting a switching control signal, corresponding to a result to analyze change of the voltage, to the switching unit,
wherein the electric power controller is installed in a printed circuit board of a junction box and electrically connected thereto.

13. The electric power controller as set forth in claim 12, wherein the electric power controller is integrated with the junction box as compliant pins of the electric power controller are inserted into throughholes in the printed circuit board of the junction box.

14. The electric power controller as set forth in claim 12, wherein:
the controller outputs determination information of the abnormal current according to the change of the voltage; and
the electric power controller further comprises a diagnostic information output unit for storing the determination information of the abnormal current and outputting the same to the outside.

15. The electric power controller as set forth in claim 14, wherein the diagnostic information output unit notifies an external vehicle controller of the determination information of the abnormal current.

16. The electric power controller as set forth in claim 12, wherein the controller controls the switching unit to switch its OFF state to its ON state when receiving a reset signal from an external vehicle controller.

17. The electric power controller as set forth in claim 12, wherein the voltage detector outputs the voltage to an external vehicle controller.

18. The electric power controller as set forth in claim 12, wherein the voltage detector comprises:
an element for measuring the voltage of the vehicle battery; and
an amplifier for amplifying a voltage difference between terminals of the element.

19. The electric power controller as set forth in claim 12, wherein the controller adjusts occurrence intervals of switching control signals corresponding to respective ON and OFF states to control the magnitude of effective value of the vehicle power supplied to the vehicle load via the switching unit.

20. The electric power controller as set forth in claim 19, wherein the controller reduces a magnitude of power supplied to the vehicle load if the vehicle battery outputs transient current.

21. An electric power controller for a vehicle, comprising:
an overheat detector for detecting whether a power line supplying power from a vehicle battery to loads is overheated;
a voltage detector for detecting a voltage of the vehicle battery;
a voltage converter for converting power from the vehicle battery into a proper voltage and outputting a switching control signal reflecting the proper voltage;
a switching unit for performing ON/OFF switching operations based on the switching control signal to control power from the vehicle battery to the vehicle load loads; and
a controller for inputting an overheat signal from the overheat detector and the voltage from the voltage detector, determining whether there is an abnormal current, and outputting a switching control signal, corresponding to a result to analyze a change of the voltage, to the switching unit,
wherein the electric power controller is installed in a printed circuit board of a junction box, and electrically connected thereto by a line connector such that one end of the line connector is connected to an input/output interface terminal of the printed circuit board and the other end thereof.

22. The electric power controller as set forth in claim 21, wherein:
the controller outputs determination information of the abnormal current according to the change of the voltage; and
the electric power controller further comprises a diagnostic information output unit for storing the determination information of the abnormal current and outputting the same to the outside.

23. The electric power controller as set forth in claim 22, wherein the diagnostic information output unit notifies an external vehicle controller of the determination information of the abnormal current.

24. The electric power controller as set forth in claim 21, wherein the controller controls the switching unit to switch its OFF state to its ON state when receiving a reset signal from an external vehicle controller.

25. The electric power controller as set forth in claim 21, wherein the voltage detector outputs the voltage to an external vehicle controller.

26. The electric power controller as set forth in claim 21, wherein the voltage detector comprises:
an element for measuring a voltage of the vehicle battery; and
an amplifier for amplifying a voltage difference between terminals of the element.

27. The electric power controller as set forth in claim 21, wherein the controller adjusts occurrence intervals of switching control signals corresponding to respective ON and OFF states to control the magnitude of effective value of the vehicle power supplied to vehicle load via the switching unit.

28. The electric power controller as set forth in claim 27, wherein the controller reduces the magnitude of power supplied to the vehicle loads if the vehicle battery outputs a transient current.
